(19) United States
(12) Patent Application Publication
(10) Pub. No.: US 2019/0141950 A1
(43) Pub. Date: May 16, 2019

(54) MEDICAL TREATMENT CLOTHING PREVENTING THE PATIENT FROM REACHING THE WOUND FOLLOWING OPERATION AND INJURY

(71) Applicant: Emirhan Yaramanci, Bor/Nigde (TR)

(72) Inventor: Emirhan Yaramanci, Bor/Nigde (TR)

(21) Appl. No.: 16/097,352

(22) PCT Filed: Jun. 29, 2016
(86) PCT No.: PCT/TR2016/050201

§ 371 Date: Oct. 29, 2018

(30) Foreign Application Priority Data
Apr. 28, 2016 (TR) 2016/05532

(51) Int. Cl. A01K 13/00; D06P 1/00; A01N 59/00; A01N 25/34; D04B 1/16; D04B 21/16

(52) U.S. Cl. CPC A01K 13/006; D06P 1/0008; A01N 59/00; D10B 2331/10; D04B 1/16; D04B 21/16; D10B 2509/022; A01N 25/34

(57) ABSTRACT

The invention relates to a medical treatment clothing used following surgical operation on domestic animals in case of injury, which prevents the animal from reaching the wound, and therefore enables the animal to return to its routine life in short time. The invention particularly relates to production of fabrics comprising Polyamide or Polyester yarns made of filament fibers and 2-50% polyurethane fibers known as Lycra for medical treatment clothing, and to the production method thereof.

### THE RELATED ART

The invention relates to a medical treatment clothing that is used following surgical operation on animals, particularly felidae and canidae in case of their injury, which prevents the animal from reaching the wound, and therefore enables the animal to return to its routine life in short time.

The invention particularly relates to production of fabrics comprising Polyamide or Polyester yarns made of filament fibers and 2-50% polyurethane fibers known as Lycra for medical treatment clothing, and to the production method thereof.

### THE PRIOR ART

Cats, dogs and many other animals act with the instinct of healing their wounds by licking them by their nature. Wounds cause both intensive pain and itching during the recovery period. This results in the desire in animals to tamper with their wound area constantly by their instinct. However, exposure of the wound to such a thing following operation causes the stitches put in the operation area to be torn and opened, and the wound to become more complicated as well as infecting the area.

In the prior art embodiments, domestic animals suffer greatly following operations. In post-operative care, one must dress the wound frequently and keep it open for the recovery to be quick while preventing the animal from licking the wound and other contacts. Various methods are still used to ensure this situation.

One of the methods used in the prior art embodiments is to apply bitter spray on the wound area. This prolongs the recovery period, and irritates the wound as well as increasing the risk of wound infection. In such embodiments, the animal is unable to lick its wound, but it causes the wound area to be damaged by scratching it with its foot or brushing it against something.

One of the most preferred methods, which is also mentioned in the United States patent document no. U.S. Pat. No. 3,036,554, is an apparatus called “Elizabeth Collar”. However, the animal is unable to feed, drink water and has difficulty in resting as long as the Elizabeth Collar is attached. Moreover, the owner must remove this apparatus frequently for the animal to feed and then attach again. It is quite difficult to use the apparatus for animals weighing 30 kg and above. The animal can remove the collar out of its neck by using its feet or do harm on the wound by scratching it with its foot if the pains and itches increase during the recovery period. As a result, the stitches may be opened.

Apart from that, the wound contacts with the environment directly as the animal lies down or gets up; correspondingly, both the wound gets infected and the environment and goods are contaminated by liquids-medications on the dressing. In consequence of such undesirable cases, the patient is often faced with much more serious complications due to problems arising after the operation, and the patient may even die of post-operation complications even if the operation has been successful.

In case of fractures, sprains and strains in extremities and other bones; the damaged area must stay till for a time. Plaster bandage method is intensively used for this purpose. However, plaster bandage is mostly too heavy for the animal's body and affects its post-operation comfort negatively although it ensures local immobility for the animal. Apart from that, while recovery period and blood stream cannot be tracked in the fractured area in plaster bandage, muscle weakness (atrophy) is commonly found in the area after the plaster bandage has been removed in animals that have carried it for a long time. The flexible bandage used in mild fractures and strains is also pretty irritating for domestic animals, and they are mostly unwilling to use it and try to remove it with their teeth when they get a chance. Apart from this, broken bone fractures pierce the skin and get out in cases of compound fractures particularly arising from traffic accidents, or the plaster bandage must be windowed and the wound must be intervened through the window while inserting a pin into the bone. However, animals also try to lick and bite this wound. Likewise, such wounds require to be dressed and the animal must not intervene in them. For this purpose, Elizabeth Collar needs to be attached to the animal as well as plaster bandage or elastic bandage, and consequent problems arise again.

Apart from such cases, sometimes animals try to scratch and bite their wounds during skin infections (Eczema, Trichophytosis-Fungus, scabies, dermatitis, allergy, abscess . . . ), as well. Even simple lesions that would heal in a few days with an effective treatment become much more complicated with the intervention of the animal. As a result, it both prolongs the recovery period and causes loss of time and money.

Consequently, all the methods used affect the life quality of the patient adversely. These methods can be barely used by domestic animal owners and make it difficult for the physician to intervene in the operational area. In addition, domestic animal can easily reach the wound area and affect the recovery period negatively.

In present embodiments, the wound gets infected more easily; liquids, creams and suchlike medications on dressing spread around, or atrophy (muscle weakness) or circulatory disorders develop due to long-term immobility.

Clothing for wound dressing is mentioned in the United States patent document no. U.S. Pat. No. 7,004,922. The invention mentioned in this document is used for animals that have incision and wound on their body. The clothing requires to be taken off to renew the wound area's dressing and then put back on. But it cannot be used for injuries on the feet and other areas. In addition, it does not have a supporting structure for fractures, sprains and strains of extremities and other bones.

One of the most important problems in the clothing used in the present art is the fabric content and technical incompetence of the fabric. The materials used for the production of the fabric are lacking flexibility and medical anti-bacterial characteristics, causes much greater complications.

Another important problem in the clothing used in the present art is insufficient wound ventilation. As sufficient wound ventilation cannot be ensured, there is a much greater risk for the wound to get infected and the anaerobic microorganisms to reproduce.

One of the problems in the medical treatment clothing used in the prior art is stitch tissues and structures. Because different stitching methods are used, the medical clothing is nondurable and can be deformed by the animal in a very short time.

### PURPOSE OF THE INVENTION

The invention solves all the problems mentioned above at the same time. The present invention, in the most general sense, relates to the production of fabric comprising Polyamide or Polyester yarns made of filament fibers, raw materials of which are not found in nature and derived from synthesis of petroleum and hard coal, and polyurethane fibers known to comprise Lycra in the amount of 2-50% in medical treatment clothing, and to the production method thereof.

The purpose of the invention is to provide the animal with ease of use and comfort after the operation and to ensure that the animal can perform its feeding and other needs easily.

A purpose of the invention is to provide ease of use and ensure that it can easily be removed by the owner, when necessary.

Another purpose of the invention is to ensure that the apparatus cannot be removed by the domestic animal in any way; and thus be safer.

The most significant purpose of the invention is to certainly prevent the domestic animal from intervening in the wound.

Another purpose of the invention is to ensure that the wound can be accessed by the owner or the healthcare personnel easily and the dressing or necessary procedures can be carried out easily.

Another purpose of the invention is to ensure that the wound is healed in short time and without complication.

A purpose of the invention is to prevent development of muscular atrophies (muscle weakness) in cases of fractures or sprains, thanks to the use of lighter material.

Another purpose of the invention is to minimize the risk of interruption of blood stream in case of fractures, cracks, and sprains that might occur in extremities (forearm and hind legs), chest area, and spine, and ensure tracking of the recovery period.

Another purpose of the invention is to ensure that the product covers the body better, and tolerate the slimness-fatness difference within the same body.

Another purpose of the invention is to ensure that the product is abrasion resistant, and therefore become a long-lasting product by retaining its appearance.

Another purpose of the invention is to show resistance to environmental factors and to fungus, mold, moth, and other harmful pests.

Another purpose of the invention is to comprise a chemical finish to make it stain-proof and dirt-proof, and therefore to ensure that the product stays clean.

Another purpose of the invention is to comprise microcapsules inside the fabric in the manner they are positioned inside the fabric, and therefore improve the patient's comfort by using substances such as antibiotic, wound powders, antiseptic, and natural and synthetic flower essences with pleasant odor, and to accelerate the treatment process.

### DETAILED DESCRIPTION OF THE INVENTION

The invention is a medical treatment clothing used following surgical operation on animals in case of injury, prevents the animal from reaching the wound, and therefore enables the animal to return to its routine life in short time. The most important element in the invention is the fabric of medical treatment clothing. This fabric comprises Polyamide or Polyester yarns made of filament fibers, raw material of which is not found in nature, and which is derived from synthesis of petroleum and hard coal, and 2-50% polyurethane fibers known as Lycra. The fabric is obtained by combining any one of the polyamide or polyester yarns with polyurethane yarns. Combination process is performed in knitting and weaving machinery. The knitting technique used while knitting the fabric is rachel knitting technique, and this is done by interlock knitting method.

After the fabric is obtained, the fabric becomes a printed fabric by a variety of printing techniques via dyeing one side of the fabric with figures, patterns, and texture themes using dye. Or, the dye is attached to the fabric by keeping under water by using dyes in dyeing kiers at 50° C. for at least 40 to 90 minutes. Silver Nitrate, Citric Acid, etc. components that are relevant chemicals as antimicrobial-antiallergic finish are added to the kier during attachment of the dye to the fabric. In addition, Ag⁺, Cu⁺², Zn⁺² Cations can also be used. As another finishing, fluorocarbon-based water repellent finishing agent is used as water repellent and waterproof finish. Permethrin is used as ectoparasitary chemical finishing; Fluorocarbon-based substance as dirt-proof and stain-proof finishing; tabasco and its essences as bitterness finishing; inorganic salts (Ag⁺, Cu⁺², Zn⁺²) and surfactant agents as antifungal finishing. Also, microcapsules are positioned inside the fabric; and for this purpose, the microcapsules prepared with Antibiotics (Rifamycin, etc.), Zn-containing wound powders, Antiseptics (Iodine preparates, etc.), and natural and synthetic flowers essences with pleasant odor are integrated and attached to the fabric at different treatment phases through various methods. When these processes are completed, the fabric is dried and smoothened by being passed through hot-rolls under a certain tension. The fabric obtained is wrapped in rolls and conditioned for 24-48 hours at room temperature.

On the conditioned fabrics, film lamination is applied, which has a standard not to impair the elastane rate of the fabric, ensures liquid-tightness on one surface of the fabric or between two fabrics, covers the whole fabric, does not lose its texture integrity and does not become deformed in applications of tension, stretching, and lateral forces. Hotmelt type lamination technique is applied in order to prevent the fabric from losing its flexibility. Lamination is made by applying bonding process in the range of 100-110° C. While there may be one layer of film and one layer of fabric at the lamination step, there may also be a middle layer of film on the exterior surfaces of both fabrics.

Laminated, finished, dyed, treated, or printing processed fabric product is ready for cutting and processing.

The stitches should be on the exterior surface during production in order not to irritate the body. Surplus parts of the fabric should be out of the body and on the exterior surface, or the ends of the fabrics should be knitted by putting them directly against each other. However, it must be noted that the stitching technique used in knitting or stitching conforms to the elastane property of the fabric. The stitches surrounding the product should be elastane in proportion to fabric, so that the fabric is not resistant to elastane property. For this purpose, preferably, single needle zigzag lock stitching is used. With this method, the tearing risk of the stitch is eliminated, and maximum conformity is ensured between the stitch and elastane property of the fabric. Binding made of elastane fabric, patters with elastane property, and coverstitch can also be used.

1. The invention is a medical treatment clothing used following surgical operation on animals in case of injury, in order to prevent the animal from reaching the wound, and therefore ensure that the animal returns to its routine life in short time, and it is characterized in that; it comprises a fabric comprising yarns made of filament fibers, raw material which is not found in nature, and which is derived from synthesis of petroleum and hard coal, and 2-50% polyurethane fibers.

2. The invention is a production method of a medical treatment clothing used following surgical operation on domestic animals in case of injury, in order to prevent the animal from reaching the wound, and therefore ensuring that the animal returns to its routine life in short time, and it is characterized in that; it comprises the operation steps of:
combining yarns made of filament fibers via synthesis from petroleum and hard coal with polyurethane yarns,
placing the fabric obtained as a result of the combining process and the dye and finishing to be applied into hot water and allowing binding of the fabric to the dye and the finishing for 40 to 90 minutes,
drying the final fabric,
smoothing the final fabric,
conditioning the fabric for 24-48 hours at room temperature,
cutting the fabric,
stitching the fabric, and
forming the final state of the medical treatment clothing.

3.-4. (canceled)

5. The fabric according to claim 2, and it is characterized in that; where in said the combining of yarns made of filament fibers via synthesis from petroleum and hard coal with polyurethane yarns with polyurethane fibers is performed by knitting operation.

6.-7. (canceled)

8. The finishing applied in claim 2, and it is characterized in that; where in said the finishing is antimicrobial-antiallergic finishing.

9. The antimicrobial and anti-allergic finishing according to claim 2 or claim 8, and it is characterized in that; it comprises silver nitrate.

10.-11. (canceled)

12. The finishing applied in claim 2, and it is characterized in that; where in said the finishing is water repellent and water tightness finishing.

13. (canceled)

14. The finishing applied in claim 2, and it is characterized in that; where in said the finishing is ectoparasitary chemical finishing.

15. (canceled)

16. The finishing applied in claim 2, and it is characterized in that; where in said the finishing is dirtproof and stainproof finishing.

17. (canceled)

18. The finishing applied in claim 2, and it is characterized in that; where in said the finishing is bitterness finishing.

19. (canceled)

20. The finishing applied in claim 2, and it is characterized in that; where in said the finishing is antifungal finishing.

21. (canceled)

22. The fabric according to claim 1 or claim 2, and it is characterized in that; where in said the fabric comprises micro capsules that contact the animal and that are applied to the inner part.

23.-27. (canceled)

28. The fabric according to claim 1 or claim 2, and it is characterized in that; it comprises application of film lamination on mentioned fabric in order to provide the fabric with resistance during complete covering of the fabric, waterproofing of the fabric, and applications of tension, stretching, and lateral forces on the fabric.

29. (canceled)

30. The medical treatment clothing production method according to claim 2, and it is characterized in that; where in said the stitches are left at the outer part of the medical treatment clothing.

31. (canceled)

32. The medical treatment clothing production method according to claim 2, and it is characterized in that; where in said the stitching method is in conformity with the elastane structure of the fabric and it is single needle zigzag lock stitch, which eliminates the tearing risk of the stitch.
